(19) United States
(12) Patent Application Publication
(10) Pub. No.: US 2009/0260224 A1
(43) Pub. Date: Oct. 22, 2009

(54) Device and Method for Securing Accessories to Fused Beads

(76) Inventors: Michael D. Wilcox, Austin, TX (US); Bradley J. Wilcox, Superior, CO (US)

Correspondence Address: HUSCH BLACKWELL SANDERS LLP, 1620 DODGE STREET, SUITE 2100, OMAHA, NE, 68102, US

(21) Appl. No.: 12/427,050

(22) Filed: Apr. 21, 2009

Related U.S. Application Data
(60) Provisional application No. 61/046,514, filed on Apr. 21, 2008.

(51) Int. Cl. B23P 19/00

(52) U.S. Cl. 29/700

(57) ABSTRACT

A device for attaching an accessory to an array of fused beads includes a head and a shank. The head may include an ornamental device that is formed as a single unitary body with the head, or an ornamental device may be attached to the head. The shank may be configured to fit snuggly within the axial cavity of one of the beads in the array.

### CROSS REFERENCE TO RELATED APPLICATION

This application is a non-provisional of U.S. Application Ser. No. 61/046,514 filed on Apr. 21, 2008, titled System and Method for Securing Accessory to Fused Beads which is incorporated by reference herein in its entirety.

### BACKGROUND OF THE INVENTION

This application relates to devices for attaching accessories to fused beads. In particular, the application relates to devices for securing ornamental devices to arrays of fused beads.

Fused beads are used in a variety of craft related products. One such product are PERLER BEADS which use cylindrical polymeric beads. The beads can be arranged in an array and fused by applying heat. The heat softens or melts one end of the beads arranged in a plane to fuse the array together. The resulting fused array has a plurality of cylindrical openings corresponding to each of the original beads. While enjoyable to use in the creation of arrays, the existing kits do not allow for the addition of ornamental devices to the arrays. This results in only color variations along the dimensions of the array which, while enjoyable to create and display, are bland. Accordingly, there is a need for a device to attach ornamental devices to an array of fused beads.

### BRIEF SUMMARY OF THE INVENTION

A device for attaching an accessory to an array of fused beads includes a head and a shank. The head may include an ornamental device that is formed as a single unitary body with the head, or an ornamental device may be attached to the head. The shank may be configured to fit snuggly within the axial cavity of one of the beads in the array.

### BRIEF DESCRIPTION OF SEVERAL VIEWS OF THE DRAWINGS

FIG. 1 is a perspective view of n array of fused beads.

FIG. 2 is an elevation view a plurality of devices for securing accessories to an array of fused beads.

FIG. 3 is an elevation view of the devices of FIG. 2.

FIG. 4 is an elevation view a plurality of devices for securing accessories to an array of fused beads.

FIG. 5 is an elevation view of the devices of FIG. 4.

FIG. 6 is a perspective view of a device for securing accessories to an array of fused beads.

FIG. 7 is a side elevation view of the device for securing accessories to an array of fused beads of FIG. 6

FIG. 8 is another side elevation view of the device for securing accessories to an array of fused beads of FIG. 6

### DETAILED DESCRIPTION OF THE INVENTION

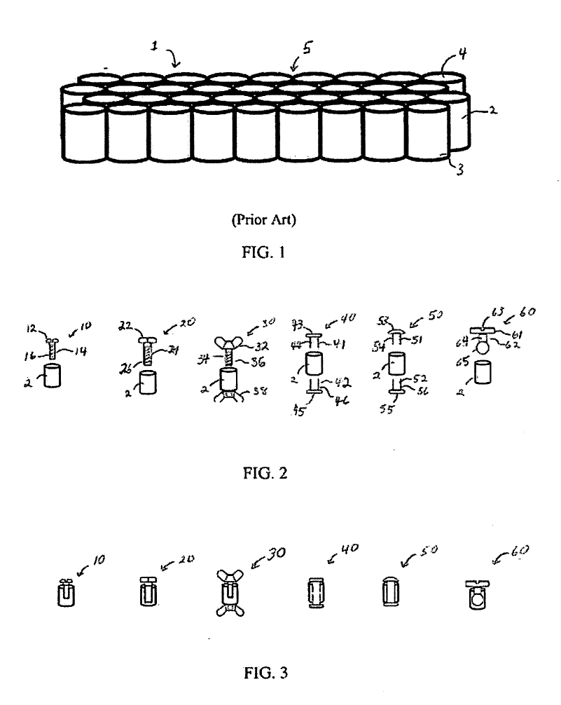

Referring to FIG. 1, a prior art array 1 of fused beads includes individual beads 2. Each bead 2 comprises an outer surface 3 and an axial opening 4. The beads are generally cylindrical in shape and are fused by the application of heat along a surface 5 of the array. The heating of the polymeric beads results in softening or melting of a portion of each bead that then fuses with the softened or melted material of adjoining beads. Openings 4 remain exposed after the array 1 has been fused.

Referring to FIGS. 2 and 3, a variety of proposed devices for attaching accessories to an array of beads (such as that shown in FIG. 1) are shown. FIG. 2 generally shows each of these devices outside of bead 2, while FIG. 3 shows the each device installed in a bead. Device 10 is comparable to a machine screw but may be made of plastic or other polymer. Device 10 comprises a head 12 and a shank 14. Shank 14 may include threads 16 that engage an interior surface of an axial opening in bead 2. Device 10 may be made of a material harder than the material of bead 2 such that device 10 is self-tapping and the threads actively engage the inner surface of opening 4. In some embodiments, the length of shank 14 may be selected such that no part of device 10 extends past an end of bead 2 distal to head 12.

Device 20 is comparable to a bolt but may be made of plastic or other polymer. Device 20 comprises a head 22 and a shank 24. Head 22 may have a variety of head configurations including a hex head, slotted head, cross-slotted head, or simply a flat head. Shank 24 may include threads 26 that engage an interior surface of an axial opening in bead 2. Device 20 may be made of a material harder than the material of bead 2 such that device 20 is self-tapping and the threads actively engage the inner surface of opening 4. In some embodiments, the length of shank 24 may be selected such that no part of device 20 extends past an end of bead 2 distal to head 22. Device 30 is comparable to a bolt but may be made of plastic or other polymer. Device 30 comprises a head 32 and a shank 34. Head 32 may have wings for facilitating hand installation. Shank 34 may include threads 36 that engage an interior surface of an axial opening in bead 2. Alternatively, the diameter of shank 34 may be smaller than the diameter of opening 4. Device 30 may be made of a material harder than the material of bead 2 such that device 30 is self-tapping and the threads actively engage the inner surface of opening 4. Shank 36 generally extends beyond the end of bead 2 distal to head 32, and may be secured by a nut 38, such as a wing nut.

Device 40 is comparable to a snap fitting having an upper potion 41 and a lower portion 42. Upper portion 41 may include a head 43 and a shank 44 while lower portion 42 includes head 45 and shank 46. One of shanks 44 and 46 may be a male portion of a snap while the other of shanks 44 and 46 is configured as a female portion of a snap.

Device 50 is comparable to a two piece rivet having an upper potion 51 and a lower portion 52. Upper portion 51 may include a head 53 and a shank 54 while lower portion 52 includes head 55 and shank 56. One of shanks 54 and 56 may be a male portion of a snap while the other of shanks 54 and 56 is configured as a female portion of a two piece rivet. In other embodiments, a single piece rivet may be used.

Device 60 comprises a head 61 and a shank 62. Head 61 may be provided with an optional slot 63 to facilitate installation. Alternatively, head 61 may be cross slotted or texturized. Shank 62 comprises a body 64 and an enlarged ball 65. Body 64 serves to separate ball 65 from head 61. When installed, ball 65 contacts the interior surface of opening 4 and provides a friction fit for device 60.

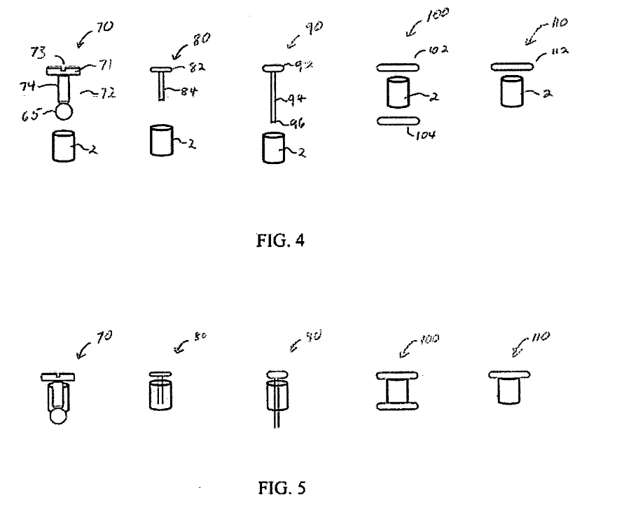

Referring to FIGS. 4 and 5, Device 70 comprises a head 71 and a shank 72. Head 71 may be provided with an optional slot 73 to facilitate installation. Alternatively, head 71 may be cross slotted or texturized. Shank 72 comprises a body 74 and an enlarged ball 75. Body 74 serves to separate ball 75 from head 71. When installed, ball 75 extends beyond an end of bead 2 distal to head 71. The resilient nature of the material used to manufacture bead 2 results in opening 4 returning to a diameter smaller than the diameter of ball 75 thereby restricting the movement of device 70 relative to bead 2.

Device 80 includes a head 82 and a shank 84. When installed shank 84 extends into opening 4 and contacts an inner surface of opening 4 to provide a friction fit that restricts movement of device 80 relative to bead 2.

Device 90 includes a head 92 and a shank 94. When installed shank 94 extends into opening 4 and contacts an inner surface of opening 4 to provide a friction fit that restricts movement of device 90 relative to bead 2. In some embodiments, shank 94 may be provided with an end 96 that is configured to extend beyond an end of bead 2 distal to head 92. End 96 may be used to engage a supporting surface on which the bead array is mounted.

Device 100 is a magnetic device for mounting an accessory to an array of fused beads. Upper portion 102 and lower portion 104 are held in place by mutual magnetic attraction. An ornamental device may be mounted to or formed as a single unitary body with upper portion 102.

Device 110 includes a single mounting device 112 that may be adhesively coupled to an array of fused beads. An ornamental device may be mounted to or formed as a single unitary body with mounting device 112.

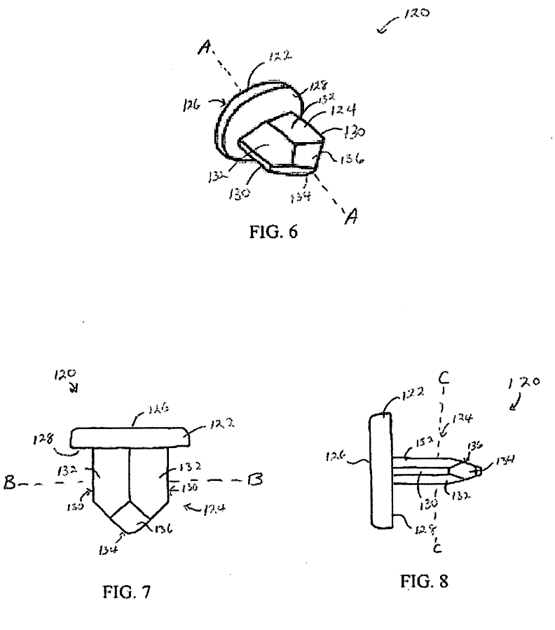

Referring to FIGS. 6, 7, and 8, a device 120 for securing an accessory to an array of fused beads may include a head 122 and a shank 124. Shank 124 is coupled to head 122 and extends perpendicular to head 122 along a line A-A. Line A-A will generally coincide with an axis of an opening 4 of bead 2 when device 120 is installed in an array of fused beads. Head 122 includes an upper surface 126 and an under surface 128. Under surface 128 is configured to contact the top of a bead that is part of a fused array. Upper surface 126 may include an ornamental device or design. Alternatively, upper surface 126 may be provided with one or more structures to facilitate mounting of an ornamental device to device 120. Shank 124 extends to a point distal to head 122 and has a generally diamond cross section devined by surfaces 132. The diamond cross section is configured such that a major axis B-B extends through opposing flats 130, and a minor axis C-C extends perpendicular thereto.

Flats 130 are spaced apart by a distance roughly equal to or slightly larger than the diameter of opening 4. Flats 130 are defined laterally by edges that actively engage (i.e. bite into) the inner surface of opening 4 when installed to provide a snug friction fit. Shank 124 is tapered to allow for easier installation into the opening 4 of a bead 2. The length of shank 124 (i.e. the distance from under surface 128 to the point of shank 124 most distal thereto) may be roughly equal to or less than the thickness of an array of fused beads such that no portion of device 120 extends beyond an end of bead 2 distal to head 122 when device 120 is installed.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that relative terms are intended to encompass different orientations of the device in addition to the orientation depicted in the Figures.

Moreover, it will be understood that although the terms first and second are used herein to describe various features, elements, regions, layers and/or sections, these features, elements, regions, layers and/or sections should not be limited by these terms. These terms are only used to distinguish one feature, element, region, layer or section from another feature, element, region, layer or section. Thus, a first feature, element, region, layer or section discussed below could be termed a second feature, element, region, layer or section, and similarly, a second without departing from the teachings of the present invention.

It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Further, as used herein the term “plurality” refers to at least two elements. Additionally, like numbers refer to like elements throughout.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow. The scope of the disclosure is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims.

What is claimed is:

1. A device for mounting an ornamental feature on an array of fused beads, the device comprising:
a head;
a shank coupled to the head and extending perpendicular thereto, the shank having
a cross section that extends, along at least one direction, a distance roughly equal to or greater than a diameter of one of the fused beads; and
a length measured from an underside of the head to a point on the shank most distal to the head, wherein the length is roughly equal to or less than the thickness of the array of fused beads.

2. The device of claim 1, wherein the shank is configured to actively engage an interior surface of a bead opening.

3. The device of claim 1, wherein the device is configured to engage with only one bead in the array.

4. The device of claim 1, wherein the cross section includes a major axis and minor axis.

5. The device of claim 1, wherein the shank is tapered.
